(19) United States
(12) Patent Application Publication
(10) Pub. No.: US 2006/0145124 A1
(43) Pub. Date: Jul. 6, 2006

(54) Method for preparing YAG fluorescent powder

(75) Inventors: Ching-Sung Hsiao, Hsinchu City (TW); Ting-Wei Huang, Hsinchu City (TW); Ming-Shiann Shih, Pingjhen City (TW); Jau-Chyn Huang, Hsinchu City (TW); Chun-Ju Huang, Jhubei City (TW); Ming-Shyong Tsai, Tainan City (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 11/319,542

(22) Filed: Dec. 29, 2005

(30) Foreign Application Priority Data
Dec. 31, 2004 (TW) 093141763

(51) Int. Cl. C09K 11/08

(52) U.S. Cl. 252/301.4 R

(57) ABSTRACT

The present invention relates to a process of making YAG fluorescence powder which comprises steps of: (a) providing a first solution of anions and a second solution of cations; (b) mixing the first solution of anions and the second solution of cations drop by drop and forming a precipitate; (c) collecting the precipitate and drying it; (d) annealing the precipitate under a pre-determined temperature until powder occurs; (e) sintering the annealed powder with a plasma torch for at least once; and (f) collecting the sintered powder.

### BACKGROUND OF THE INVENTION

1. Field of the Invention

The present invention relates to a method for preparing fluorescent powder and, more particularly, to a method for preparing yttrium aluminum garnet (YAG) fluorescent powder.

2. Description of Related Art

Yttrium aluminum garnet (YAG) possesses high hardness, high heat-transferring coefficient, low inflating coefficient and other significant properties that make it an excellent matrix material. By doping with a little of luminous rare earth elements into YAG to replace yttrium, the product of which can be used as a fluorescent material; for example, doping cerium into the YAG lattice would turn it into fluorescent powder emitting yellow glow; to have the yellow fluorescent powder combined with the blue glow in the light emitting diode (LED) can turn out to be a white LED; if Terbium, Europium, Cobalt or Samarium were to be doped in the YAG lattice, it would form fluorescent powder glowing with red or green luminescence.

Conventional techniques in preparing the fluorescent powder can be generalized as follows:

(1) Solid state method, using metal oxide or metal carbonate as the starting materials and doping with rare earth elements for luminescence purpose. After being mix-polished or ball-polished proportionally and sintered at 1500° C., the product is formed; however, during the course of the preparation, the powder needs to be polished and sintered repeatedly for 4 to 6 days to complete the whole process. Furthermore, the quality of the product prepared by this method varies, as, after sintering under high temperature for a long period of time, the particles of the powder often turn out to be oversized, and the luminescence is rather weak.

(2) Co-precipitation method, using yttrium nitrate and aluminum nitrate as the raw materials and using oxalic acid, citric acid, carbonate acid or ammonia as the precipitate reagent; utilizing the characteristic of the identical precipitate rate allows the metallic ions in the solution to form metal-insoluble salt. Then after filtering and drying, an evenly-sized precursor is obtained, with a particle size as small as nanometer-level. Since the activity of the starting material is great, the sintering temperature in the reaction can be maintained lower than that in the solid-state reaction but has to be higher than 1000° C. for 5 to 24 hours of sintering in order to have the YAG fluorescent powder having the particle size of 10 um.

(3) Sol-gel method, using mainly dicarboxylic acid mixed with metal salts, and using polyalcohol as solvent to stir and heat to form metal alkoxide compounds. The sol gel is formed after hydrolyzation, and then after being further thermalyzed, the powdered precursor is obtained. Next, sintering at 1000° C. and higher for 24 hours obtains the YAG fluorescent powder. Similarly, it is fairly difficult to obtain ball-shaped powders of nanometer level from sintering at such a high temperature, and using the metal alcohol salt compounds as the starting material is costly, consequently increasing the cost of production.

(4) Combustion synthesis, flame-burning the nitrate or the organic fuel directly at a temperature higher than 1600° C. to produce the YAG phase in a relatively swift manner; however, the unevenness of the powder obtained causes a poor quality of the product overall.

(5) Hydrothermal method, allowing the YAG powder to be synthesized at the temperature as low as 500° C.; however, in order to obtain the YAG powder, the synthesis requires roughly 20 hours under the pressure of 100 MPa.

From the above it is known that using conventional methods for preparing the high-quality YAG powder of nanometer level is an extremely difficult task that requires long preparation time and expensive equipment and is comparatively not suitable for industrial applications.

### SUMMARY OF THE INVENTION

The present invention provides a method for preparing nanometer-level fluorescent powder by combining advantages of both the co-precipitation and the use of the plasma torch to be able to prepare a high-luminance, nanometer-leveled fluorescent powder. Such method as mentioned above not only can shorten the preparation time from the conventional methods, but also be able to prepare ball-shaped and nanometer-leveled fluorescent powder with much less effort.

The method for preparing fluorescent powder of Yttrium Aluminum Garnet (YAG) of the present invention comprises the steps as follows: (a) providing a first solution of anions and a second solution of cations; (b) mixing the first solution of anions and the second solution of cations through dripping to form a precipitate; (c) collecting and drying the precipitate; (d) annealing said dried precipitate to form powder; (e) sintering the powder in a plasma torch; and (f) collecting the sintered powder.

In step (a) of the method of the present invention, the composition of the first solution of anions is not specified yet preferably comprises oxalic acid, citric acid, ammonium carbonate, ammonia or the mixture thereof; similarly the composition of the second solution of cations is not specified either yet preferably comprises a nitrate or oxide of (Y₃-ₐRₐ)Al₅O₁₂, in which R is an element of rare earth, Cerium (Ce), Dysprosium (Dy), Gadolinium (Gd), Europium (Eu), Terbium (Tb), Lanthanum (La), Praseodymium (Pr), Neodymium (Nd), Samarium (Sm) or Cobalt (Co) can be doped of demand for various colors of light, and the a in the formula of nitrate or nitrate oxide is 0.01 to 0.2.

In step (b) of the method of the present invention, in order to allow the precipitate to form a YAG phase without any other occurrence of blur phases, using the dripping method to mix the first solution of anions with the second solution of cations is the most effective means; the order in mixing the solutions is not restricted yet preferably has the first solution of anions dripped into the second solution of cations slowly, preferably at a rate of 0.5 to 5 milliliters per minute.

Before proceeding to annealing, the precipitate, preferably having been cleansed, undergoes the process prior to annealing as in step (c), in which the powdered precipitate is first dried, preferably at 80 to 100° C. for 12 to 36 hours. The most suitable temperature and time are 95° C. and 24 hours respectively.

In step (d) of the method of the present invention, the temperature for annealing the powdered precipitate is not specified yet preferably in the range of 800 to 1500° C., best at 900° C.; the annealing temperature is increased under a gradual heating process, in which the temperature is preferably increased at a rate of 5 to 15° C. per minute, best at 10° C. per minute. The annealing taken place in step (d) preferably continues for 0.5 to 12 hours; however, for the time- and energy-saving purposes, an hour of annealing time would be preferably enough to obtain nanometer-level YAG powder.

In step (e) of the present invention, types of the plasma torch thereof are not restricted, but a negative-pressure type microwave plasma torch is preferred; the plasma gases used for the microwave plasma torch are not restricted either, but helium, hydrogen, nitrogen, air or the combination thereof are preferred; the pressure used for the said microwave plasma torch is not restricted, but 20 to 740 Torr is preferred and 20 to 200 is optimum. Also in step (e) of the present invention, the temperature for sintering the power after annealing is not limited; however, in order to obtain the powder with evenly-sized particles, the sintering temperature in the range from 2000° C. to 4000° C. is preferred; at the same time, number of times of sintering will affect the degree of luminance of powder in direct proportion, thus the number of times of sintering is subject to change, but 3 to 6 times is preferred.

### BRIEF DESCRIPTION OF THE DRAWINGS

FIG. 1 is an XRD mapping of the precursor for preparing the fluorescent powder by the co-precipitation method in Example 1 of the preferred embodiment according to the present invention.

FIG. 2 is a TEM result of the precursor for preparing the fluorescent powder by the co-precipitation method in Example 1 of the preferred embodiment according to the present invention.

FIG. 3 is a TEM result of the yellow YAG fluorescent powder having been sintered for 5 times with a microwave plasma torch.

FIG. 4 is an XRD result of the powder after being solid-state sintered at 1500° C. for an hour.

FIG. 5 is a TEM result of the powder after being solid state sintered for an hour.

### DETAILED DESCRIPTION OF THE PREFERRED EMBODIMENT

The present invention first uses a co-precipitation method to produce a YAG phase at a low temperature around 1000° C.; then, by combining the use of a microwave plasma torch having a high-temperature flame (more than 3000° C.), the YAG can rapidly be annealed and form a powder, allowing the YAG to be softened or even melted, in which ball-shaped nanometer-level powder can be obtained as a result.

### Example 1

Taking the preparation of yellow fluorescent powder for an example, nitrate or nitrate oxide comprising formula of (Y₃-ₐRₐ)Al₅O₁₂ (wherein a is 0.01˜0.2) is first prepared as 100 ml of 0.2M cation solution according to the stoichiometric ratio; further, 100 ml of 1M anion solution made of ammonium carbonate is prepared as well. Then the anion solution is slowly dripped into the cation solution, at a constant rate of 1 ml per minute; during the course of this step, if the solution is added too quickly or the cation solution is reversely dripped into the anion solution instead, some of intermediates, such as YAP or YAM, may occur aside from the YAG phase precipitate. Later the precipitate product is cleansed with de-ionized water for 3 times after filtering, and the product is then dried below 95° C.

The precipitate after drying becomes the precursor of the fluorescent powder. After preheating the precursor for an hour at various temperatures between 800 to 1500° C. and increasing at 10° C. a minute, the powder obtained is then conducted with both XRD and TEM analyses.

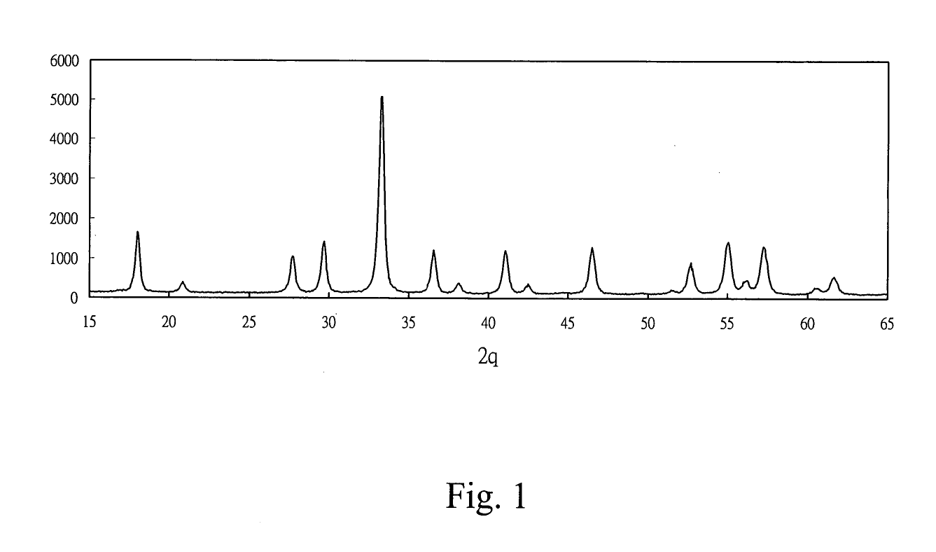

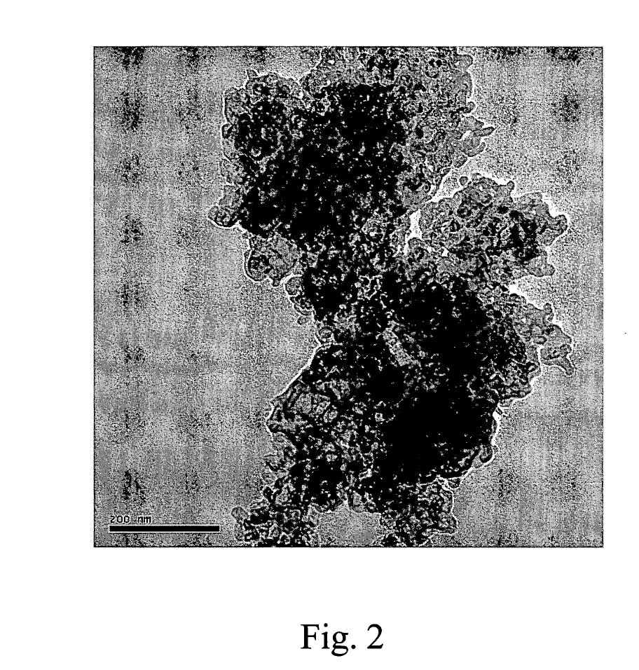

The results are as shown in FIG. 1 and FIG. 2, where the XRD analysis in FIG. 1 shows that an hour of annealing at 900° C. can produce YAG, and the TEM results in FIG. 2 show the primary particle size is 20 nm, and the secondary particle size is 300 nm.

### Example 2

Having the powder, which was derived and conducted with XRD and TEM analyses from example 1, and sintered for numerous times, the yellow fluorescent powder can be obtained; the microwave plasma torch used in this example is a negative pressured type device, in which the operational range is between 20 and 740 Torr, and the plasma gases used for the torch are helium, hydrogen, nitrogen, air or the combination thereof.

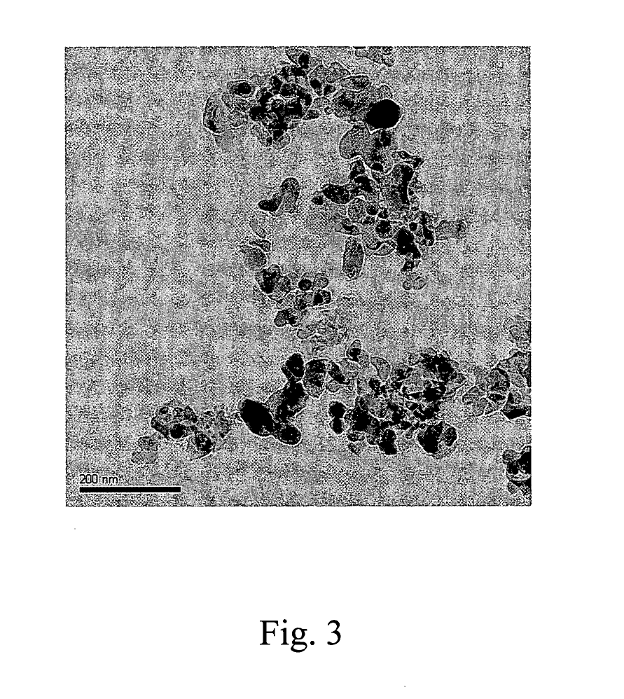

The yellow fluorescent powder that has been sintered by the microwave plasma torch is then conducted with both TEM and photoluminescence (PL) analyses. FIG. 3 is the result of the TEM scanning, showing that after 5 times of sintering with the microwave plasma torch, the primary particle size of the yellow YAG fluorescent powder is less than 50 nm.

### Comparative Example

The yellow fluorescent powder prepared by the solid-state method and that described in Example 2 are compared with each other.

The solid-state reaction method is to mix-polish Y₂O₃, A₁₂O₃ and CeO₂, which were prepared according to their stoichiometric ratio. The mixture is then sintered in a solid state at 1500° C. for 1, 12 and 24 hours respectively and analyzed afterward for XRD, TEM and photoluminescence analysis.

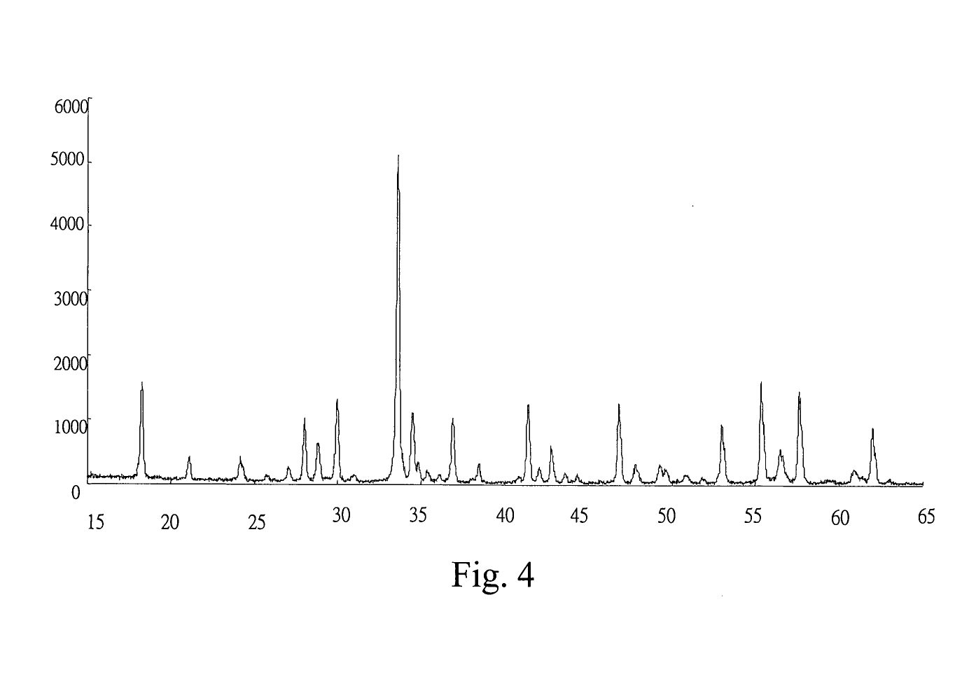

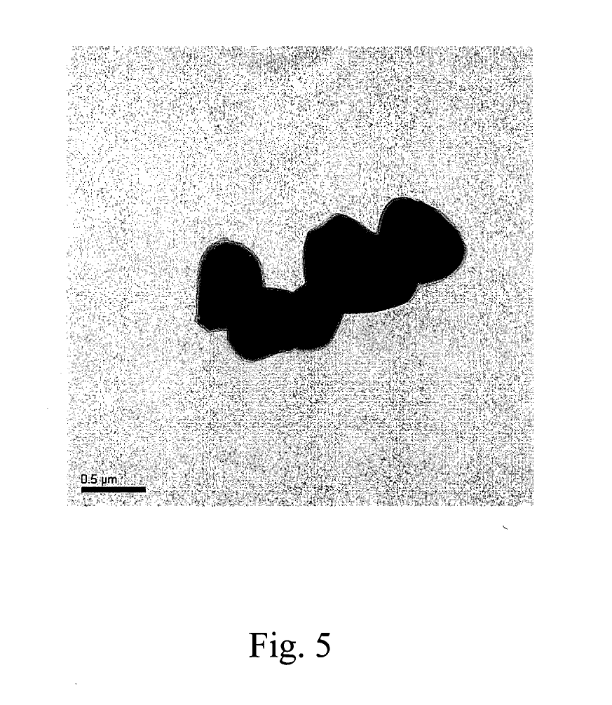

FIG. 4 shows the XRD result of the powder being sintered in a solid state for an hour at 1500° C., from which some blur phases can still be observed aside form the YAG phase; FIG. 5 shows the TEM result of the powder being sintered in a solid state for an hour, in which the primary particle size is greater than 500 nm. Table 1 lists the PL results, in which sample 1 through 3 were the results of the preparation using the solid-state sintering. After being sintered in the solid state for an hour, there are still some blur phases other than YAG within the product; as the sintering reaches more than 12 hours, pure YAG phase can then be obtained. Also, in the case of sintering below 1500° C., the intensity of photoluminescence at 537 nm will increase as the sintering time increases and be able to reach the maximum at 1773 a.u. after 12 hours of sintering. The intensity of photoluminescence, however, decreases to 935 a.u. when the sintering time is extended to 24 hours. The intensity of photoluminescence of the powder prepared by the co-precipitation method in Example 1 is merely 765 a.u. as shown as the sample 4 in Table 1; however, after being annealed under the various conditions shown in Example 2, the PL result, as shown as the sample 5 through 9 in Table 1, shows that the precursory powder, which was prepared by the co-precipitation method, is able to turn into high-photoluminous YAG fluorescent powder after being sintered with the plasma torch.

TABLE 1

| Sam- | | | | |
|---|---|---|---|---|
| ple | Composition | Preparing Method | XRD/SEM | PL (537 nm) |
| 1 | As mentioned | Solid state sintering | YAG phase | 1650 a.u. |
| | in Comparative | (1500° C., 1 hour) | with few | |
| | Example | | blur phases | |
| 2 | As mentioned | Solid state sintering | YAG phase | 1773 a.u. |
| | in Comparative | (1500° C., 12 hour) | | |
| | Example | | | |
| 3 | As mentioned | Solid state sintering | YAG phase | 935 a.u. |
| | in Comparative | (1500° C., 24 hour) | | |
| | Example | | | |
| 4 | As mentioned | Annealing | YAG phase | 765 a.u. |
| | in Example 1 | (900° C., 1 hour) | | |
| 5 | As mentioned | Sample 1 + plasma | YAG phase | 1059 a.u. |
| | in Example 2 | torch (1 time) | | |
| 6 | As mentioned | Sample 1 + plasma | YAG phase | 1428 a.u. |
| | in Example 2 | torch (2 times) | | |
| 7 | As mentioned | Sample 1 + plasma | YAG phase | 1513 a.u. |
| | in Example 2 | torch (3 times) | | |
| 8 | As mentioned | Sample 1 + plasma | YAG phase | 1955 a.u. |
| | in Example 2 | torch (4 times) | | |
| 9 | As mentioned | Sample 1 + plasma | YAG phase | 2178 a.u. |
| | in Example 2 | torch (5 times) | | |

Although the present invention has been explained in relation to its preferred embodiment, it is to be understood that many other possible modifications and variations can be made without departing from the scope of the invention as hereinafter claimed.

What is claimed is:

1. A method for preparing fluorescent powder of Yttrium Aluminum Garnet, comprising following steps:
(a) providing a first solution of anions and a second solution of cations;
(b) mixing said first solution of anions and said second solution of cations through dripping to form a precipitate;
(c) collecting and drying said precipitate;
(d) annealing said dried precipitate to form powder;
(e) sintering said powder with a plasma torch; and
(f) collecting said sintered powder.

2. The method of claim 1, wherein said first solution of anions comprising oxalic acid, citric acid, ammonium carbonate, ammonia or the mixture thereof.

3. The method of claim 1, wherein said second solution of cations comprising a nitrate or nitrate oxide of (Y₃-ₐRₐ)Al₅O₁₂, in which R is an element of rare earth, Cerium (Ce), Dysprosium (Dy), Gadolinium (Gd), Europium (Eu), Terbium (Tb), Lanthanum (La), Praseodymium (Pr), Neodymium (Nd), Samarium (Sm) or Cobalt (Co), and the a in the formula of nitrate or nitrate oxide is 0.01 to 0.2.

4. The method of claim 1, wherein said dripping in step (b) is to have said first solution of anions dripped into said second solution of cations.

5. The method of claim 1, wherein said dripping in step (b) is at a rate of 0.5 to 5 milliliter per minute.

6. The method of claim 5, wherein said rate of dripping is 1 milliter per minute.

7. The method of claim 1, wherein the conditions of said drying in step (c) are at 80 to 100° C. and for 12 to 36 hours.

8. The method of claim 7, wherein the conditions of said drying in step (c) are at 95° C. and for 12 hours.

9. The method of claim 1, wherein said temperature in step (d) is in the range from 800 to 1500° C.

10. The method of claim 9, wherein said temperature in step (d) is 900° C.

11. The method of claim 1, wherein said temperature in step (d) is increased at a rate of 5 to 15° C. per minute.

12. The method of claim 11, wherein said temperature in step (d) is increased at 10° C. per minute.

13. The method of claim 1, wherein said annealing in step (d) lasts 0.5 to 12 hours.

14. The method of claim 13, wherein said annealing in step (d) lasts 1 hour.

15. The method of claim 1, wherein said plasma torch is a negative-pressure type microwave plasma torch.

16. The method of claim 7, wherein the gases used for said plasma torch in step (d) are helium, hydrogen, nitrogen, air or the combination thereof.

17. The method of claim 7, wherein the pressure used for said microwave plasma torch in step (d) is 20 to 740 Torr.

18. The method of claim 1, wherein said sintering temperature in step (e) is 2000 to 4000° C.
